(19) United States
(12) Patent Application Publication
(10) Pub. No.: US 2012/0299254 A1
(43) Pub. Date: Nov. 29, 2012

(54) STROKE SHORTENING ADAPTER FOR RECIPROCATING POWER TOOL

(76) Inventor: Kerry A. Wanstrath, Durango, CO (US)

(21) Appl. No.: 13/479,511

(22) Filed: May 24, 2012

Related U.S. Application Data
(60) Provisional application No. 61/489,540, filed on May 24, 2011.

(51) Int. Cl. B25F 3/00

(52) U.S. Cl. 279/143

(57) ABSTRACT

A stroke shortening adapter for use with a reciprocating power tool which holds a cutting tool at one and is affixed to the shaft of the power tool at the opposite end. The adapter provides two coaxial body portions which are nested and axially slidable with respect to one another. A compression spring is retained in a central chamber between said portions to bias the portions to an axially extended position. The axial stroke of the power tool is partially absorbed by axial movement between said portions and compression of the spring.

This application claims the benefit of provisional application No. 61/489,540 filed May 24, 2011 and which is incorporated herein by reference.

### BACKGROUND OF THE INVENTION

The present invention provides an external adapter to shorten and dampen the stroke of a commercially available reciprocating saw as may be desirable to facilitate using such a saw for cutting through the urethane adhesive used to attach windshields to the pinchweld of an automobile.

### SUMMARY OF THE INVENTION

The main purpose of this invention is to shorten the length of the stroke of a standard reciprocating saw such as manufactured by companies such as Dewalt Tools and Milwaukee Tool Company. While such reciprocating saws are intended primarily for use with a toothed saw blade having its cutting edge along one side, they may also be fitted with a broad, flat-bladed cutting tool similar to a putty knife or spatula having a sharpened leading cutting edge to remove damaged automotive windshields by cutting though the adhesive polyurethane bead which retains the windshields.

While a typical “off-the-shelf ” reciprocating saw has a stroke of 0.75 to 1.5 inches in length, and is a fixed unattenuated mechanical movement. This stroke is typically longer than desirable for windshield removal since it creates a “kickback” from the impact of the wide cutting blade as it comes into contact with the hardened urethane adhesive. This can making it difficult to use and reduce its effectiveness in cutting through the urethane.

A shorter stroke produces a smoother stroke for the tool operator. The longer stroke creates bounce as the blade makes and loses contact with the urethane adhesive. A shorter stroke provides faster cutting because the cutting blade can remain in contact with the urethane being cut, rather than bouncing off because of the heavy vibration of the reciprocating or oscillating movement.

Therefore, the stroke of the reciprocating saw is preferably modified and shortened to improve the functionality of the saw tool for this purpose. The present invention shortens the stroke without requiring modification of any the machine's internal mechanical parts such as gears, cams or shafts. This invention is attached to the shaft of the reciprocating saw in place of and in the same manner as a normal saw blade and provides for further attachment of an appropriate cutting tool. The invention is suitable for use with any powered reciprocating tool including those which are electrically or pneumatically powered.

In addition to shortening the length of the stroke the present invention incorporates an internal compression spring which further facilitates use of a leading edge cutting tool by absorbing some of the impact shock of the resulting back and forth motion of the reciprocating saw shaft as the cutting blade makes contact with the urethane adhesive being cut. In essence, the tool provides improved control of the cutting tool by allowing application of an attenuated cutting force without unnecessary reciprocating movement. During the compression stroke this spring absorbs the impact of the blade as it comes into contact with the adhesive bead until a point where the compressive force is greater than the necessary cutting force. Upon the extension portion of the stroke extension of the spring allows the cutting edge of the blade to remain essentially in contact with the bead.

The present invention further provides a simplified and secure method of attachment of the cutting blade by providing a clamp assembly with one or more blade securing pins but only a single removable securement screw in order to facilitate easily changing the blade. This assembly further stiffens the cutting blade without other external sheath jacket or similar stiffening reinforcement.

It is an object of the present invention to provide an external adapter which can be retrofitted to a standard reciprocating saw to reduce its stroke.

It is an object of the present invention to provide a means of reducing the stroke of a standard reciprocating without mechanical modification of the saw.

It is an object of the present invention to provide a means of dampening the impact of the stroke of a standard reciprocating saw.

It is an object of the present invention to provide a means of dampening the impact of the stroke of a standard reciprocating saw without mechanical modification of the saw.

It is an object of the present invention to provide a means of keeping a forward edge cutting tool in constant contact with the material being cut while using an reciprocating tool.

It is an object of the present invention to adapt a reciprocating saw to be suitable for cutting through the adhesive bead securing an automotive windshield.

It is an object of the present invention to provide an inexpensive tool suitable for cutting through the adhesive bead securing an automotive windshield.

It is an object of the present invention to provide a secure and easily changeable method of securing a cutting tool to a reciprocating shaft.

It is another object of the present invention to provide a secure and easily changeable method of securing a cutting tool to a reciprocating shaft.

It is an object of the present invention to provide an adapter to allow securement of a cutting tool to a reciprocating power tool without any external sheath, jacket or similar stiffening reinforcement.

### DESCRIPTION OF THE DRAWINGS

FIG. 1 is a perspective view of the device of the preferred embodiment in place between a cutting blade and a reciprocating power tool.

FIG. 2 is an exploded top view of the device.

FIG. 3 is an exploded partially cutaway view corresponding to FIG. 2.

FIG. 4 is a top view showing the device in an extended configuration.

FIG. 5 is a top view showing the device in a compressed configuration.

FIG. 6 is a partially cutaway top view showing the device in an extended configuration.

FIG. 7 is a partially cutaway top view showing the device in a compressed configuration.

FIG. 8 is a side view of the device of the preferred embodiment as it would be used.

FIG. 9 is an exploded side view of the device of the preferred embodiment.

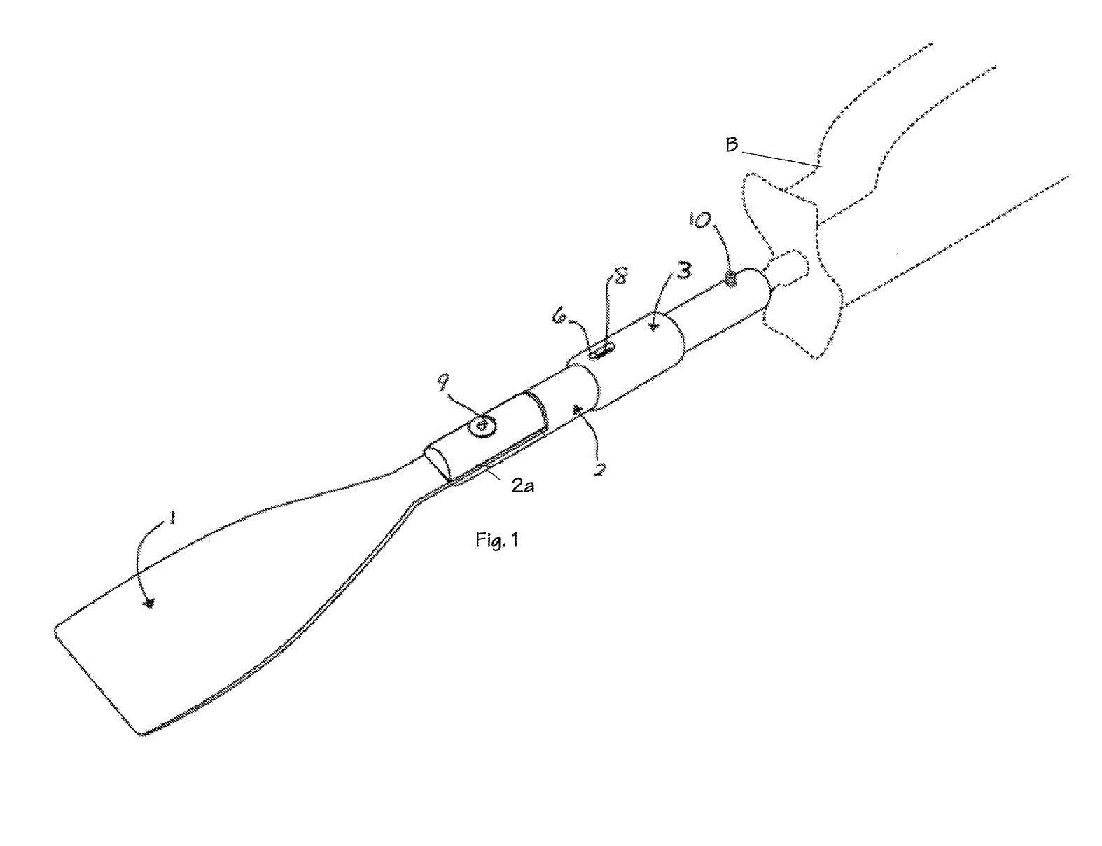

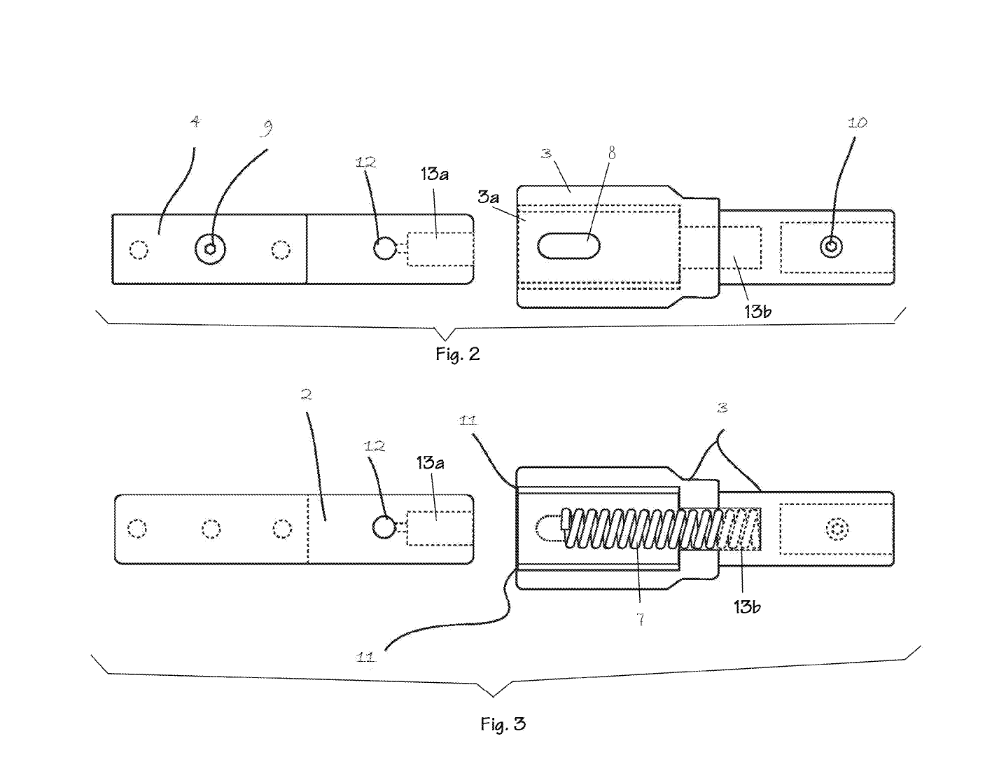

### DETAILED DESCRIPTION OF THE INVENTION

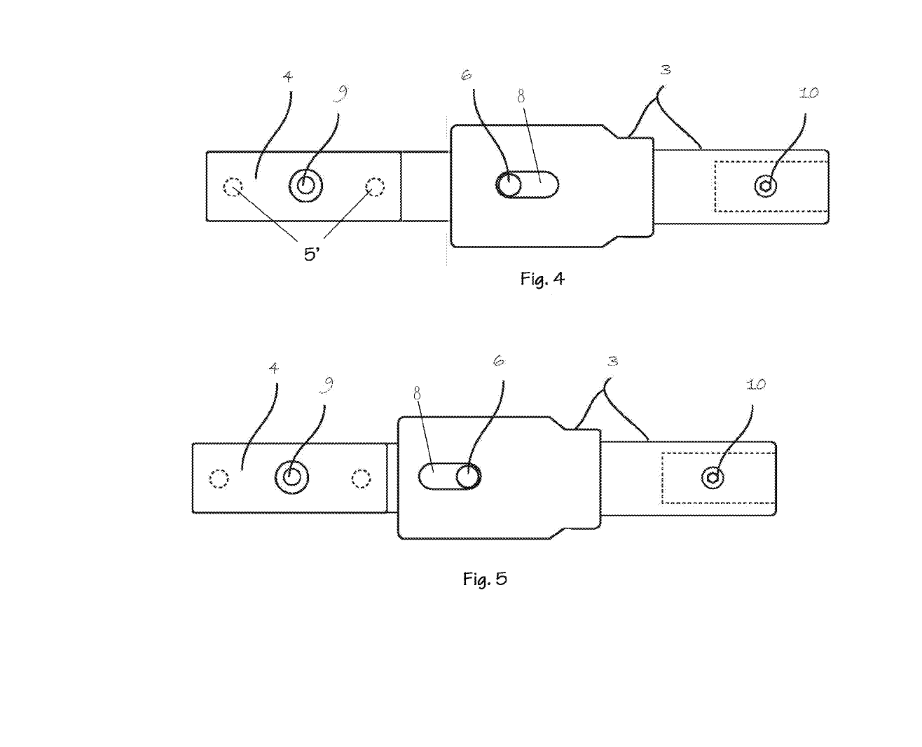

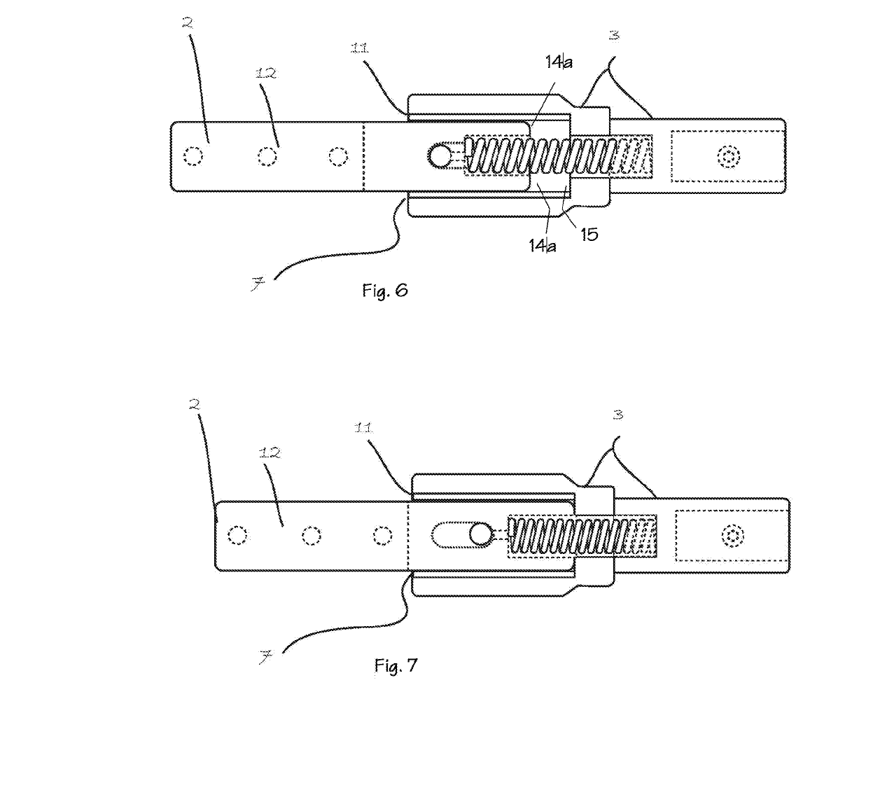

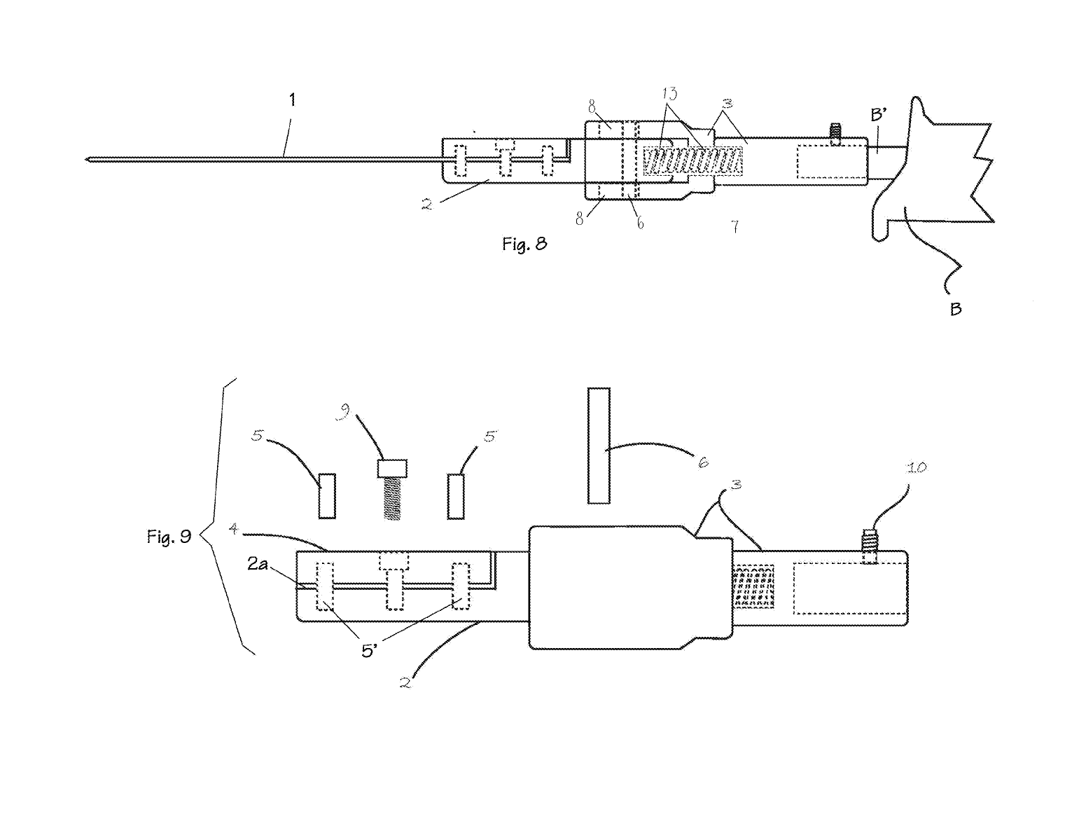

The device of the present invention is comprised of three primary components, two coaxial, nested shaft or body portions 2 and 3, which are slidable between an axially extended and an axially compressed configuration as shown in FIGS. 4 and 5 respectively. The respective body portions are nested to provide a telescoping axial movement, with body portion 2 being received into and axially slidable within correspondingly sized chamber 3a in body portion 3. Chamber 3a may be appropriately lined with a bronze or “oilite” bearing sleeve 11 for various purposes including reduction of sliding friction, improving wear resistance, and/or reducing the potential for galling of the sliding surfaces. Cylindrical chamber portions 13a and 13b combine to form a central axial chamber 13 to hold a compression spring 7 which biases body portion 2 and 3 to an extended axial position. The body portions are preferably constructed from a suitably tough and durable material such as 4130 or 4140 steel alloys but could be constructed from materials such as various aluminum alloys, synthetic or composite materials in order to achieve benefits such as light weight.

A typical cutting tool 1 is attached to shaft portion 2. Tool 1, as would be used for the specific purposes described herein, comprises a broad “spatula” type cutting blade with a leading cutting edge. Blade 1 is attached to blade connecting shaft portion 2, using a removable semi-cylindrical blade anchor cover 4 affixed and aligned with dowel pins 5 and anchoring screw 9. Use of the single anchoring screw 9 facilitates removal and installation the cutting blade. Dowel pins 5 are received into blind holes 5′ and pass through correspondingly sized holes in the blade to secure it. Blade locating pins 5 are permanently pressed into blade connecting shaft 2, blade locating cover 4 is placed so as the two locking pins 5 align in blind holes 5′ in blade locking cover 4. A single countersunk screw 9 is placed through blade locking cover 4 and threaded into blade connecting shaft 2 to secure the cutting blade 1 and prevent it from moving while tool is operational. It is to be understood that the term “cutting tool” as used herein includes any tool or device which may be attached to and driven by a reciprocating power tool.

Changing of blade 1 is facilitated by locking cover 4 being a separate removable piece, in contrast to using a slot in blade connecting shaft 2 to secure cutting blade 1. A flat surface 2a is machined in blade connecting shaft 2 to provide a seat for cutting blade 1, which is fastened in place to using blade locking cover 4 and blade locating pins 5.

At an end opposite from its attachment to a power tool shaft B, connecting shaft 3 slips over blade connecting shaft 2 to create a coaxial nested configuration. The device is assembled with compression dampening spring 7 located within a central coaxial chamber 13 inside the saw connecting shafts 2 and 3, then pressing two connecting shafts 2 and 3 together axially and securing them with anchor and guide pin 6 through travel guide slots 8 and pressed into hole 12 where it is held by its own tension. Elongated guide slots 8 have a minor dimension corresponding to the diameter of guide pin 6. Guide pin 6 can be a standard spring or tension pin which, in conjunction with elongated slots 8, allows relative axial movement while keeping the two connecting shafts 2 and 3 from separating or rotating relative to one another while the device is in operation and, further provides a limit to the extension of the device as shown in FIG. 4. The lack of relative rotational movement between the body portion insures that the orientation of a flat cutting blade can be manually controlled by an operator.

Set screw 10 is used to secure invention to the operating shaft B of a reciprocating tool. Set screw 10 is threaded down against the shaft of the tool.

In use with the device fully assembled, cutting blade 1 is placed against the urethane at the metal pinchweld area where the urethane and the glass windshield meet. As the reciprocating motion of the tool transfers into the shaft of the invention and the compression dampening spring 7, absorbs some of the stroke of the reciprocating tool. While spring 7 is preferably a suitably sized metallic coil spring any appropriate resilient and compressible material or method could similarly be used. A rubber or similar elastomeric synthetic material could be used instead of a metal compression spring 7, to absorb shock and then recoil back to its original shape and size. Similarly a body of air or gas could be contained in a cylindrical compartment between the two shafts 2 and 3, could be used to absorb some of the stroke and shock of the reciprocating tool by compression of the gas.

At the beginning of a stroke, the force against the cutting blade 1 is limited by the rate of spring 7, and increases as the spring is further compressed through the stroke. The stroke of the reciprocating tool is absorbed and or shortened until the applied force is greater than the force needed to cut the urethane adhesive.

Upon full compression of the device as shown in FIGS. 5 and 7, the end 14 of shaft 2 comes into full contact with an internal shoulder 15 of body portion 3. This effectively creates a “stop” such that all further axial motion and force of the reciprocating stroke is transferred directly to shaft 2 and the cutting tool A. In order to provide the smoothest operation of the tool it may be desirable to choose a spring having a spring rate such that when this stop is reached the force on the compressed spring is close to or equal to the force required for blade 1 to cut an adhesive bead. Shaft end 14 is appropriately provided with a circumferential chamfered edge 14a to help prevent any “mushrooming” of the shaft end from impact and limit or prevent any binding of the sliding movement of the shaft 2 within body 3.

Upon full compression the two shafts 2 and 3 act as one. At the end of the compression stroke the reciprocating tool pulls the blade back towards the tool itself. The compression spring 7, then uncompresses and pushes the two shafts 2 and 3 apart. The entire cycle starts over with every stroke of the reciprocating tool this cycle is repeats at a typical rate of 1000 to 3000 cycles per minute. This rapid cycling motion of the cutting tool cuts the adhesive material quickly. The operator keeps the blade in contact with the urethane adhesive material and adjusting the angle of the tool to facilitate a smooth cutting action.

Other variations within the scope of this invention will be apparent from the described embodiment and it is intended that the present descriptions be illustrative of the inventive features encompassed by the appended claims.

What is claimed is:

1. A stroke shortening adapter for use with a reciprocating power tool comprising,
a first body portion having an end for securement to said power tool,
a second body portion having an end for securement of a cutting tool,
said body portions being axially movable with respect to one another.
a compressible resilient spring between said portions to bias said portions to an axially extended position,
wherein a portion of the axial power stroke of the power tool is absorbed by axial movement of the said portions and compression of said spring.

2. A stroke shortening adapter according to claim 1 wherein one of said portions is at least partially nested within the other said portion.

3. A stroke shortening adapter according to claim 1 wherein at least a portion of an axial compression stroke of said power tool is fully transferred to said cutting tool.

4. A stroke shortening adapter according to claim 1 wherein the compressible resilient spring is a metallic coil spring.

5. A stroke shortening adapter according to claim 1 wherein the compressible resilient spring is comprised of an elastomeric material.

6. A stroke shortening adapter according to claim 1 wherein the compressible resilient spring is contained within a central axial chamber within said body portions

7. A stroke shortening adapter according to claim 1 wherein a cutting tool is secured with a single threaded fastener.

8. A stroke shortening adapter for use with a reciprocating power tool comprising,
a first portion having an end for securement to said power tool,
a second portion having an end for securement of a cutting tool,
said portions being coaxial and axially movable with respect to one another.
a compressible resilient spring between said portions to bias said portions to an axially extended position,
wherein a portion of the axial stroke of the power tool is absorbed by axial movement between said portions and compression of said spring.

9. A stroke shortening adapter according to claim 8 wherein at least a portion of an axial compression stroke of said power tool is fully transferred to said cutting tool.

10. A stroke shortening adapter according to claim 8 wherein there is no relative rotational movement between said body portions.

11. A stroke shortening adapter according to claim 8 wherein one of said body portions is at least partially nested within the other said body portion.
